(19) United States
(12) Patent Application Publication
(10) Pub. No.: US 2005/0045672 A1
(43) Pub. Date: Mar. 3, 2005

(54) Detergent powder dispenser for a dishwasher

(75) Inventor: Giuseppe Marone, Moncalieri (IT)

Correspondence Address: SUGHRUE MION, PLLC, 2100 PENNSYLVANIA AVENUE, N.W., SUITE 800, WASHINGTON, DC, 20037, US

(73) Assignee: ELBI INTERNATIONAL S.P.A.

(21) Appl. No.: 10/895,125

(22) Filed: Jul. 21, 2004

(30) Foreign Application Priority Data
Jul. 21, 2003 (IT) TO2003U000117

(51) Int. Cl. B67D 5/38

(52) U.S. Cl. 222/637

(57) ABSTRACT

The dispenser comprises a body in which there is defined one receptacle which can be loaded with a quantity of detergent. On the side facing the washing chamber, the receptacle has a front wall provided with a plurality of through slots facing the washing chamber. The dispenser is intended to be fixed in the washing chamber in a position such that, in operation, the water jets emerging from a spray rotor can strike the front wall of the body and partially penetrate the receptacle through the slots in order to wash out the detergent contained therein. The slots extend through the thickness of the front wall of the body in a direction corresponding to the local direction of incidence of the water jets emitted by the rotor.

The present invention relates to a detergent powder dispenser for a dishwasher comprising, in a manner known per se, a washing chamber in which there is mounted so as to be rotatable about a substantially vertical axis at least one spray rotor which emits sprays or jets of water in substantially tangential directions, in operation.

More specifically, the subject of the invention is a detergent dispenser of the type defined in the introductory part of claim 1.

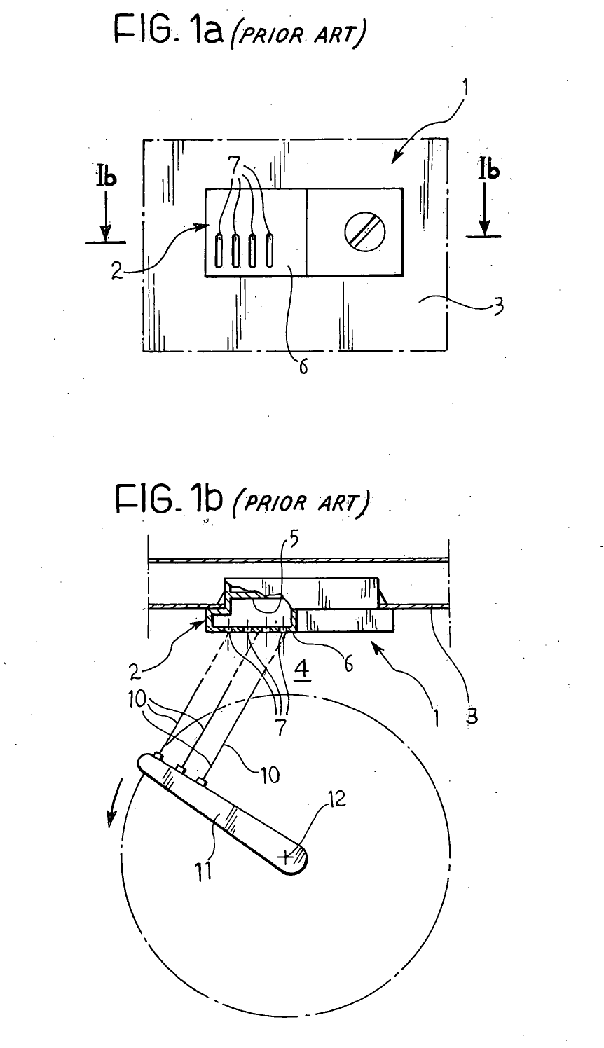

FIGS. 1a and 1b of the appended drawings show a dispenser 1 according to the prior art in a front view and in a view sectioned on the line Ib-Ib of FIG. 1a, respectively.

As can be seen in these drawings, the known dispenser 1 comprises a body 2 which, for example, is made of moulded plastics material, and which is fixed to a corresponding opening in a wall 3 which delimits the washing chamber 4 (FIG. 1b) of a dishwasher of a type known per se. The wall 3 is advantageously represented by the inner face of the tilting loading and unloading door of the dishwasher.

At least one receptacle 5 which can be loaded with a quantity of detergent powder is defined in the body 2 of the dispenser 1. On the side facing the interior of the washing chamber 4, the receptacle 5 has a front delimiting wall 6 which is provided with a plurality of through slots or slits 7 facing the washing chamber 4.

As can best be seen in FIG. 1b, the dispenser 1 is fixed in a position such that, in operation, the water jets 10 emerging from a spray rotor 11 which is rotatable about a substantially vertical axis 12 can strike the front wall 6, partially penetrating the receptacle 5 through the above-mentioned slots 7 in order to wash out the detergent contained therein.

In the dispensers according to the prior art, the slots 7 are formed in the front wall 6 of the dispenser 1 in a direction perpendicular to that wall. However, the jets 10 strike the front wall 6 in directions which are variable within a narrow angular range but in any case are not perpendicular to the wall 6.

The proportion of the water of the jets which manages to penetrate the receptacle 5 and wash out the detergent is consequently actually quite small.

The above-described disadvantage of dispensers according to the prior art is advantageously overcome by the dispenser according to the invention, the main characteristics of which are defined in appended claim 1.

Further characteristics and advantages of the invention will become clear from the following detailed description which is given purely by way of non-limiting example, with reference to the appended drawings, in which:

FIG. 1a, which has already been described, is a front view of a detergent dispenser according to the prior art,

FIG. 1b, which has also already been described, is a section taken on the line Ib-Ib of FIG. 1a, and

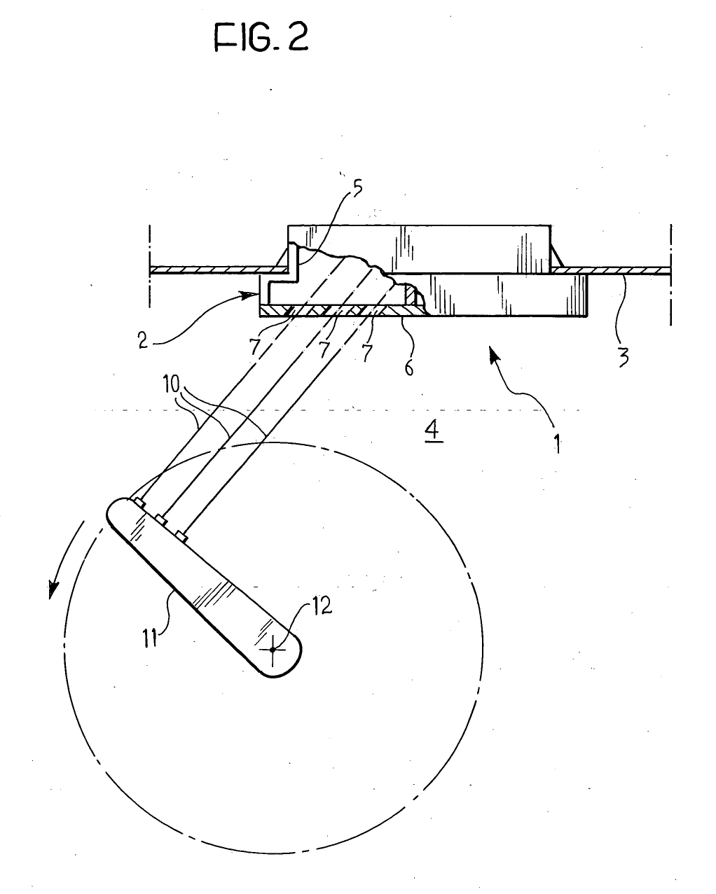

FIG. 2 is a view similar to that of FIG. 1b and shows a detergent dispenser according to the invention, partially in section.

In FIG. 2, parts and elements already described with reference to FIGS. 1a and 1b have again been attributed the same reference numerals.

In the dispenser according to the invention, as can be seen in FIG. 2, the through-slots 7 of the front wall 6 of the body of the detergent dispenser are not formed perpendicularly relative to the general plane of that wall but are formed with their respective axes and their respective vertical side-wall edges inclined in a direction which corresponds to the (mean) local direction of incidence of the water jets 10 emitted by the spray rotor 11 in operation.

By virtue of this arrangement, greater and more effective penetration of the water of the jets 10 into the receptacle 5 and more effective washing out of the detergent powder contained therein are achieved than in dispensers according to the prior art, for given dimensions of the slots.

Naturally, the principle of the invention remaining the same, the forms of embodiment and the details of construction may be varied with respect to those described and illustrated purely by way of non-limiting example, without thereby departing from the scope of protection of the present invention as defined in the appended claims.

1. A detergent powder dispenser for a dishwasher comprising a washing chamber in which there is mounted so as to be rotatable about a vertical axis at least one spray rotor which emits a plurality of sprays or jets of water, in operation,
the dispenser comprising a body in which there is defined at least one receptacle which can be loaded with a quantity of the detergent, the receptacle having, on the side facing the washing chamber, a front delimiting wall provided with a plurality of through slots facing the washing chamber, the body being intended to be fixed in the washing chamber in a position such that, in operation, the water jets emerging from the rotor strike the front wall of the body and partially penetrate the receptacle through the above-mentioned slots in order to wash out the detergent contained therein out,
the said slots extending through the thickness of the front wall of the body in a direction essentially corresponding to the local direction of incidence of the water jets emitted by the rotor.
